(19) United States
(12) Patent Application Publication
(10) Pub. No.: US 2006/0107975 A1
(43) Pub. Date: May 25, 2006

(54) Field transportable high-power ultrasonic transducer assembly

(76) Inventors: David Arguelles, Washington, DC (US); David Gross, Bethesda, MD (US); Joshua M. Luszcz, Falls Church, VA (US)

Correspondence Address: HARNESS, DICKEY & PIERCE, P.L.C., P.O. BOX 8910, RESTON, VA, 20195, US

(21) Appl. No.: 11/229,617

(22) Filed: Sep. 20, 2005

Related U.S. Application Data
(60) Provisional application No. 60/611,383, filed on Sep. 20, 2004.

(51) Int. Cl. B08B 3/10

(52) U.S. Cl. 134/56 R; 134/184

(57) ABSTRACT

The present invention relates to an improved ultrasonic cleaning system incorporating one or more improvements including, for example, permanently-attached flexible cables, waterproof bulkhead connectors provided on the transducers, submersible breakout assemblies, rigid cable guides and retainers, and at least one electronic switching unit whereby multiple ultrasonic transducers can be selectively driven by a single ultrasonic generator. The improved ultrasonic cleaning system may be configured with various transducer arrangements including, for example, elongated transducers provided on a carrying frame or structure and a more planar array configuration that may be assembled from a plurality of transducer subassemblies.

### PRIORITY STATEMENT

This U.S. non-provisional application claims benefit of priority under 35 U.S.C. § 119 from U.S. Provisional Patent Application No. 60/611,383, which was filed on Sep. 20, 2004, the entire contents of which are incorporated herein by reference.

### BACKGROUND OF THE INVENTION

1. Field of the Invention

This invention relates to the control and configuration of cleaning systems incorporating ultrasonic transducers, particularly with regard to submersible transducer assemblies suitable for use in industrial applications, and more particularly, to improvements in cleaning systems incorporating ultrasonic transducers suitable for use in high-radiation fields such as found adjacent to irradiated nuclear fuel assemblies.

2. Background Art

A common problem experienced during operation of equipment having wetted surfaces, for example, boilers, chillers, heat exchangers and reactors, is the accumulation of corrosion and/or crud on the wetted surfaces. These accumulations will tend to reduce flow rates, reduce heat transfer and/or degrade the performance of the associated system. Accordingly, various alloys and/or additive packages have been developed for suppressing corrosion of the wetted surfaces and/or the accumulation of crud on the wetted surfaces. Despite the improvements provided by new materials and/or surface treatments and/or improvements in the composition of liquid systems contained and circulated through the system, the wetted surfaces are typically subjected to periodic cleaning utilizing one or more cleaning techniques in order to remove at least some of the accumulated material from the wetted surface and recover some of the performance losses attributed to the accumulated material.

The acceptance and use of ultrasonic fuel cleaning methods continues to increase as a means for improving plant operation by suppressing Axial Offset Anomaly (AOA) conditions, a phenomenon also referred to as Crud Induced Power Shift (CIPS). This condition results from the accumulation of deposits on the fuel assembly, particularly deposits incorporating boron on the upper portions of the fuel assembly, which result in undesirable local flux depressions. Fuel cleaning, in conjunction with improved reactor vessel core design, can enable PWR and BWR reactors to operate with higher duty fuel and longer cycles. Reducing the amount of radioactive crud on the fuel assemblies will also tend to reduce the radiation dosage levels and/or dosage rates to which workers are subjected or exposed during subsequent operations with the fuel assemblies.

### BRIEF SUMMARY OF THE INVENTION

The present invention relates to an improved ultrasonic cleaning system incorporating one or more improvements including, for example, the use of permanently-attached flexible cables rather than conventional stainless steel flexible conduits normally attached to submersible transducers, the use of waterproof bulkhead connectors on the transducers in association with disconnectable flexible cable assemblies, the use of a submersible breakout assembly that allows multiple cables to be consolidated into a single flexible cable assembly, use of rigid cable guides and retainers that do not require separate fasteners for improved cables management in association with the breakout assemblies, and the use of an electronic switching unit whereby multiple ultrasonic transducers can be selectively driven by a single ultrasonic generator.

### BRIEF DESCRIPTION OF THE DRAWINGS

The invention will become more apparent by describing in detail exemplary embodiments thereof with reference to the attached drawings in which:

FIG. 1 illustrates an example of an ultrasonic cleaning system according to an embodiment of the invention;

FIG. 2 illustrates a portion of an example of an ultrasonic cleaning system according to an embodiment of the invention;

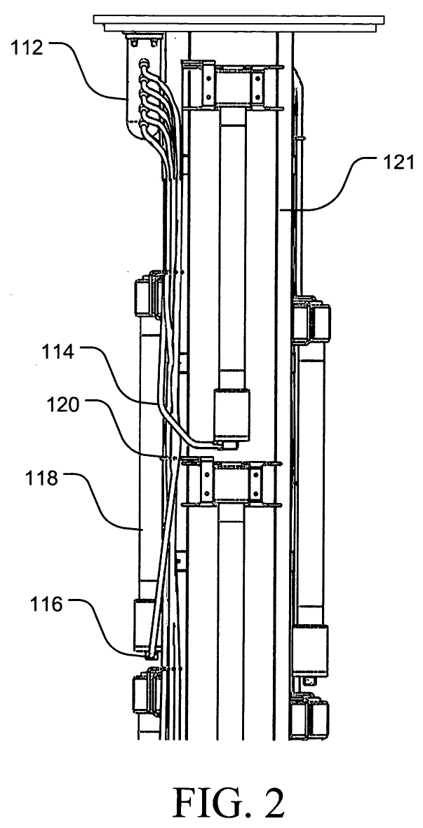

FIG. 3 illustrates detail of an example of a connector assembly suitable for use in an ultrasonic cleaning system according to an embodiment of the invention;

FIG. 4 illustrates a portion of an example of an ultrasonic cleaning system according to an embodiment of the invention;

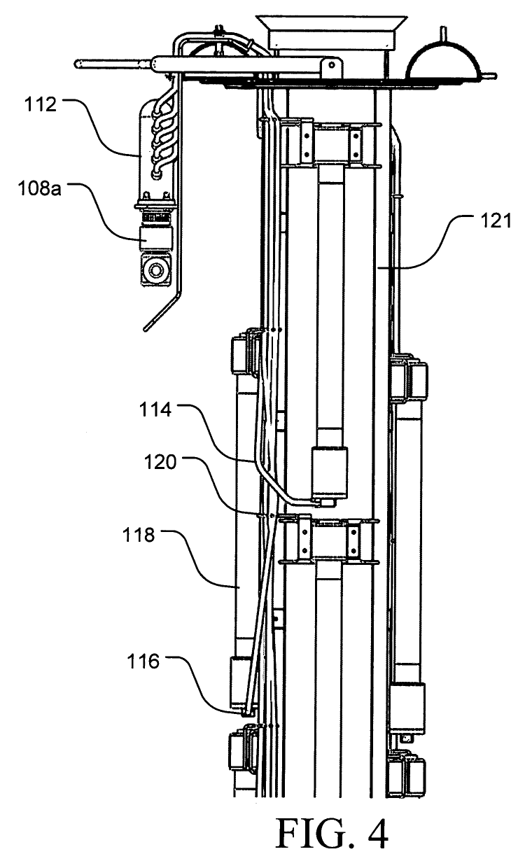

FIG. 5 illustrates an example of a cable management clip suitable for use in an ultrasonic cleaning system according to an embodiment of the invention;

FIG. 6 illustrates an example of an elongated transducer suitable for use in an ultrasonic cleaning system according to an embodiment of the invention; and

FIGS. 7A and 7B illustrate alternative configurations of transducers and transducer arrays suitable for use in an ultrasonic cleaning system according to an embodiment of the invention.

These drawings have been provided to assist in the understanding of the exemplary embodiments of the invention as described in more detail below and should not be construed as unduly limiting the invention. In particular, the relative spacing, positioning, sizing and dimensions of the various elements illustrated in the drawings are not necessarily drawn to scale and may have been exaggerated, reduced or otherwise modified for the purpose of improved clarity.

Those of ordinary skill in the art will also appreciate that a range of alternative configurations have been omitted simply to improve the clarity and reduce the number of drawings. Those of ordinary skill will appreciate that certain of the assemblies, subassemblies, fixtures and other mechanisms and hardware illustrated or described with respect to the exemplary embodiments may be selectively and independently modified and/or combined to create other configurations suitable for use in an ultrasonic cleaning system. Those of ordinary skill will also appreciate that the flexibility of the ultrasonic cleaning system and components allow for the customization and adaptation of the exemplary ultrasonic cleaning system to other specific applications without departing from the scope and spirit of this disclosure.

### DETAILED DESCRIPTION OF EXAMPLE EMBODIMENTS

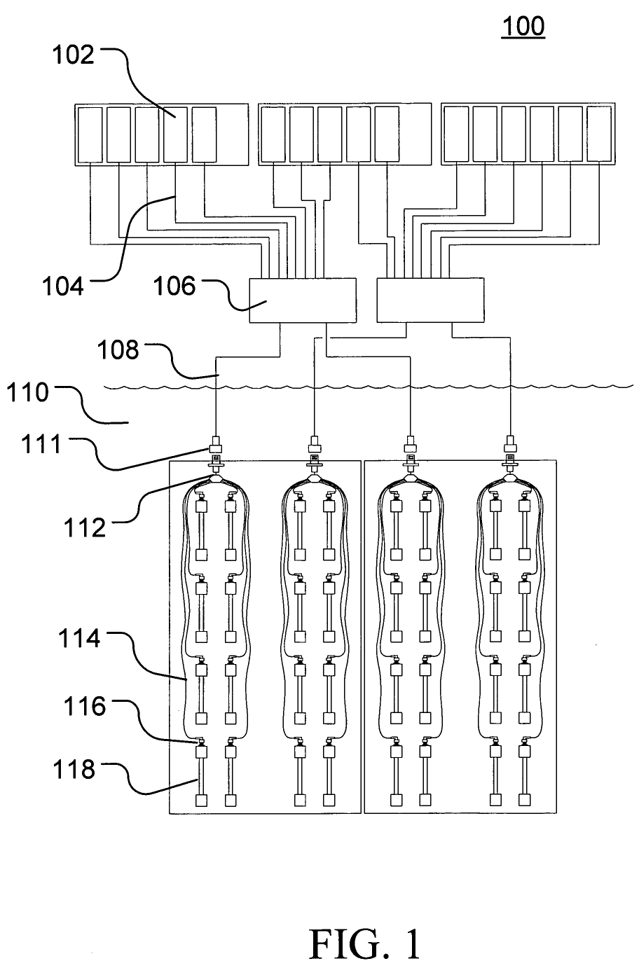

An exemplary embodiment of an ultrasonic cleaning system 100 according to the invention is illustrated in FIG. 1. As reflected in FIG. 1, a number of ultrasonic generators 102 may be connected through appropriate cables 104 and one or more optional switching units 106 to a number of ultrasonic transducers 118. By using this configuration with the incorporated switching units 106, each ultrasonic generator 102 may be used to provide or apply power to one or more ultrasonic transducers 118 in a predetermined, programmed and/or random sequence.

As illustrated in FIG. 1, the switching units 106 may be used to selectively alternate power from the generators 102 to a series of consolidated cable assemblies 108 that are associated with groups of transducers 118. Each of the cable assemblies 108 may, in turn, be connected to a breakout or distribution assembly 112 that distributes or separates these conductors into a corresponding series of cables 114, each cable typically being associated with one of the driven transducers 118.

As illustrated in FIG. 1, this exemplary embodiment of an ultrasonic cleaning system according to the invention utilizes water-tight submersible connectors 111, 116 for establishing electrical connections within a liquid 110 between both the consolidated power cable 108 and the breakout assembly 112 and between the breakout assembly legs or cables 114 and the driven transducer 118 or transducer array. One or both of these connections may, however, be achieved using other suitable connector configurations.

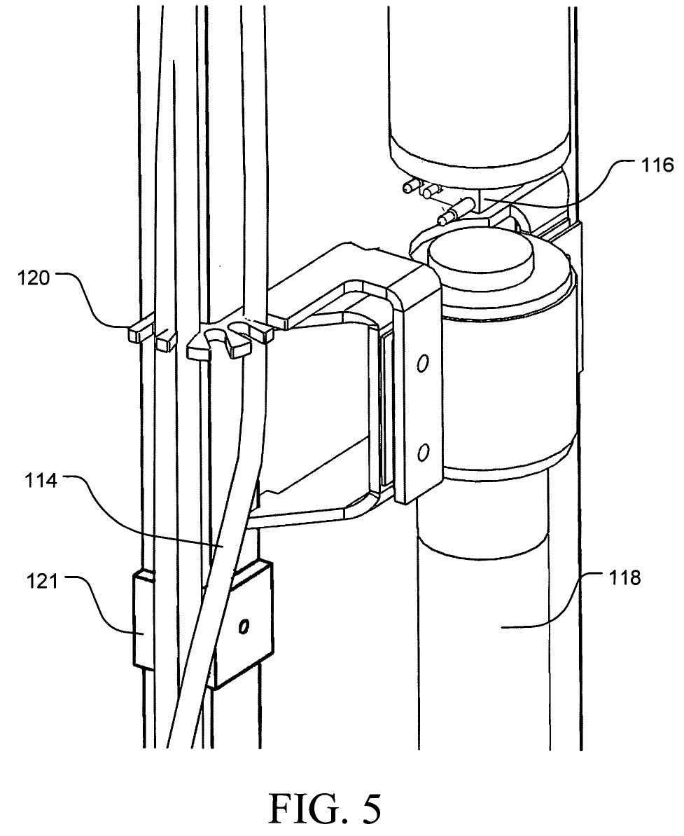

As illustrated in FIG. 5, depending on the particular configuration utilized, ultrasonic cleaning systems according to the invention may incorporate one or more cable management clips 120 integral with or attached to a primary frame 121. These exemplary cable management clips 120 are fabricated from highly inflexible (i.e., rigid) material and are provided with an opening sized for insertion, retention and removal of the cables without substantial deformation of the clip. The openings are sized whereby during insertion and removal of the cables, the generally plastic deformation or compliance of the cable insulation allows the cable cross-section to be modified sufficiently to pass through the opening without damaging the insulation or deflecting the clip. Once the cable resumes its normal configuration, its sizing will be sufficient to achieve the desired retention.

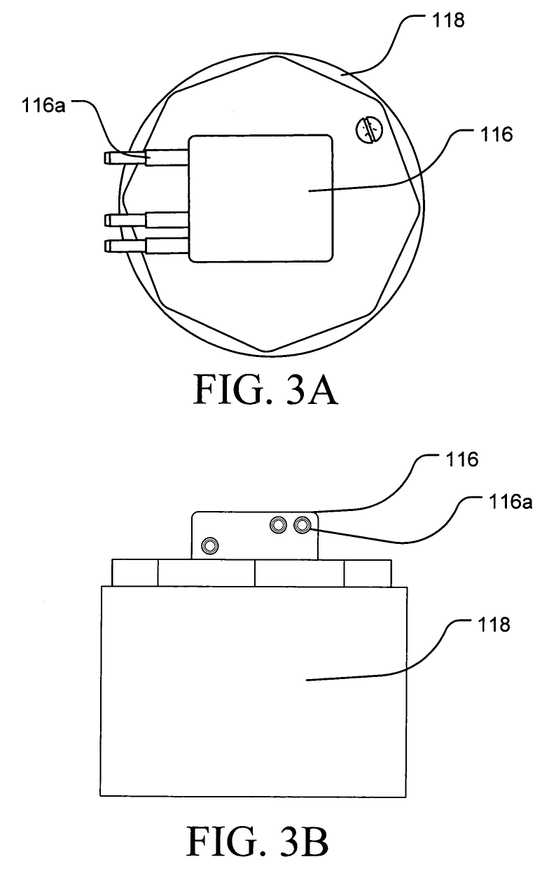

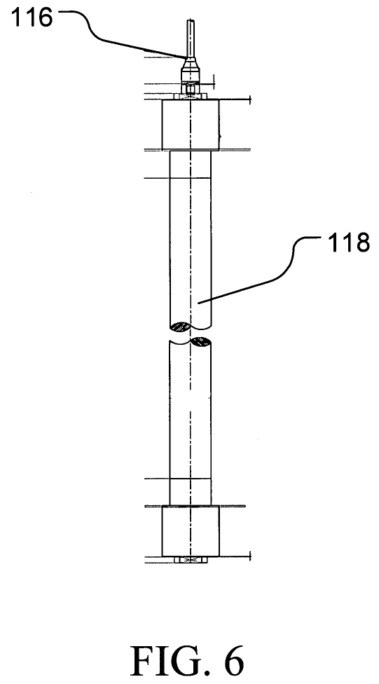

In another exemplary embodiment, the removable submersible connectors illustrated in FIG. 3 may be replaced with integral flexible cables, as illustrated in FIG. 6. Although this design would generally be used without any underwater connectors, it will still be compatible with and combined with a non-submersible breakout assembly or junction box, and/or with one or more switching units that allows a number of generators to drive a larger number of transducers. In another exemplary embodiment, those non-metallic materials, e.g., wire insulation, o-rings and gasket materials are upgraded to materials capable of withstanding radiation doses of 10⁷ rad or greater. These radiation-hardened materials may be incorporated in either of the two main exemplary configurations described above.

An exemplary electronic switching unit will typically include the following features:

The ability to switch between two or more sets, groups or arrays of transducers via either an operator activated switch, button or toggle selection or an external signal from an automated control system.

The ability to optionally consolidate a number of generator signals into a smaller number of multi-conductor cables.

The ability to switch a varying number of input generators, from a single generator up to the maximum number of input ports provided.

The ability to sense whether power is flowing from the connected generators to the connected transducers, and prevent switching under these circumstances.

The ability to consolidate or disseminate logic input signals such as, for example, a switching unit configured to pass a single “run” signal to all connected generators

A front panel and/or remote indication of switching and transducer operating status (on/off).

The ability to output switching status and error conditions in a form that can be monitored by an operator and/or an automatic data acquisition system.

This specification covers the design and configuration of an improved, field configurable high power ultrasonic assembly that includes ultrasonic transducers, generators, power control and switching equipment, cabling and submersible connectors for use in industrial scale ultrasonic field cleaning of, for example, heat exchangers and radiated nuclear fuel assemblies.

The assembly 100 will typically include a first plurality of generators 102, a second plurality of transducers 118, the number of transducers typically being an integer multiple, e.g., 2, 3, 4, etc., of the number of individual generators. The generators and the transducers may be connected through one or more switching units that allow each of the generators to be used to drive one or more transducers, typically alternatively with the generator power output corresponding to the power requirements of each of the driven transducers or transducer arrays. The generators and the switching unit(s) may be combined in a single electronics housing or enclosure.

In an exemplary embodiment, the ultrasonic cleaning assembly 100 can include N (such as sixteen (16) 1500 watt 25 kHz) ultrasonic generators coupled to and M·N (such as thirty-two (32) 1500 W 25 kHz) ultrasonic transducers. The transducers can be configured as M separate arrays of N transducers for positioning in M separate cleaning chambers or within different regions of a single cleaning chamber. Each of the transducers may include an underwater wet pluggable bulkhead connector 116 to allow for the connection and disconnection of the power cabling to the individual transducer 118. The present invention is not limited to any particular transducer configuration and may be used, for example, with both stacked and planar piezoelectric transducer configurations.

Two switching units 104 may be used for remotely or locally selecting which array or bank of ultrasonic transducers 118 will be powered by the generators 102 at a given time period. For example, N/2 (for example, eight) generators can be connected to each switching unit 104, although the switching units may include some excess capacity, with the signal wires, typically a hot, ground and neutral wire for each transducer, extending from the switching unit. The signal wires may be bundled in one or more cables 104, 108, 114 that terminate in one or more multiple pin connectors 111, 116 for connecting the signal wires to the transducer array carrier or transducer basket 121.

In a preferred embodiment, the generator output may be switched from one set of transducers to another set of transducers by an operator manipulating a single toggle switch located on the switching unit front panel (e.g., a “Local” switch) or in response to logic input signals (such as 5 VDC TTL logic, 24 VDC logic, or switch state change) transmitted from supplemental hardware separated, perhaps by a substantial distance from the electronics enclosure (e.g., “Remote” switching).

The transducer array carrier or transducer basket 121 may also include one or more breakout or distribution units 112 for separating the signal wires for each of the transducers 118. The electronics enclosure, preferably including both the generators and the switching unit(s) may be located in a rack based electronics enclosure that provides power distribution, overcurrent protection (i.e. circuit breakers), and a cooling system such as fans or an air conditioning system.

The transducers and the other submersible components should be configured so as to be suitable for operation at the anticipated operating depths, typically up to about 60 feet (18.3 meters) or more and temperatures of up to about 170° F. (77° C.). For reactor applications various components such as the gaskets, o-rings and other non-metallic components may be suitably radiation resistant so as to achieve the desired durability in the anticipated operating environment of, for example, up to 10⁶ rad/hr exposures. The transducers may also be configured in parallel with a radiation resistant or hardened (rad-hard) resistor generally corresponding to the resistance of the piezoelectric elements for diagnostic purposes.

A preferred embodiment may utilize a single multiconductor shielded cable containing thirty (30) copper multi-strand tinned conductor runs from the electronics enclosure to each submersible transducer basket. This cable will typically include a line, neutral, and protective earth ground for each of the transducers to which it will be used to supply power. The cable, in turn, may be connected to a breakout or distribution unit or assembly that will separated the primary cable into a plurality of shielded cables each containing the three (3) copper multistrand tinned conductors, e.g., the line, neutral, and protective earth ground for a single transducer. The individual cables may then be connected to each of the corresponding transducers using a removable underwater connector.

A preferred embodiment will include an IMPULSES® PLPBH-3-MP wet pluggable bulkhead connector or an equivalent 116 that will provide a removable, submersible connection at one end of an elongated transducer 118. The connector body may be molded to a stainless steel mounting stud for attachment to the transducer housing with a radiation tolerant o-ring utilized for establishing a substantially watertight seal between the connector and a transducer converter endcap. A preferred connector will include at least three copper multistrand tinned potted leads, which may be cut to length and then crimped to form an electrical connection to the piezoelectric elements during assembly.

In general, TEFLON® insulation does not provide the desired durability in the radiation fields to which the transducers may be exposed during reactor fuel rod cleaning applications. One material that is expected to provide improved durability in such environments is KYNAR® (a form of PVDF—polyvinyldiene fluoride) and is a preferred material for forming transducer components such as insulation sleeves, wiring insulation, gaskets and o-rings.

The switching units may also be configured to switch fewer than the maximum number of generator outputs in response to a particular Local and/or Remote mode input. A selector unit may be provided on or adjacent the electronics enclosure for selecting between the “Local” or “Remote” operating modes. Prior to switching the generator output, it is strongly preferred that each of the transducers that will be affected by the switching be de-energized. A safety lockout may be provided that will prevent an operator from inadvertently switching the powered transducers in either “Local” or “Remote” mode. The electronics enclosure may be provided with indicator lights or other display means for indicating the status of the ultrasonic generators, switching units and/or transducers. Means may also be provided for generating signals corresponding to the status of the various components to allow for remote monitoring of the performance of the assembly.

The equipment located inside the electronics enclosure should be configured to be easily serviceable. For example, it is preferred that the individual components (i.e., generators, switching unit(s), circuit breaker(s)) be removable and replaceable without disturbing the existing cable management and configuration. Similarly, it is preferred that all cables should be readily accessible and replaceable without necessitating the removal or repositioning of other major pieces of equipment. Cables and wiring will preferably be installed in wire-ducts where practical to facilitate easy access and replacement.

The front panels for the generators and the switching unit, as well as any breakers or main power switches, will preferably be accessible after opening the front door of the electronics enclosure. The operator will preferably be protected from all live components when the front door is open and the front door may typically be opened while the system is energized. Conversely, there will typically be an interlock on the rear door that both prevents the rear door from being opened while the system is energized and prevents the system from being energized while the door is opened with all live components prior to the cutoff point being protected and/or shielded from accidental contact when the door is open.

The electronics enclosure is preferably sufficiently durable to prevent or reduce damage associated with contact and impacts that will typically be sustained during shipping, assembly and relocation of the unit. Similarly, the components and/or connectors housed within the electronics enclosure should be fixed in such as manner as to prevent or reduce movement resulting from vibrations or other movement during shipping, assembly and relocation of the unit. The electronics enclosure may be provided with one or more swivel hoist rings, typically arranged at the upper corners, and/or other hard points or lifting fixtures that singly or collectively have a working load rating sufficient for the generally safe movement of the electronics enclosure. The electronics enclosure may also be provided with castors or other means to allow for movement across a relatively level surface.

The single phase loads and the unbalanced loads for each of the generators will preferably be distributed as evenly as reasonably possible between the supply phases, typically utilizing three phase power. The electronic enclosure is also preferably configured to provide a NEMA 12 equivalent enclosure, i.e., an enclosure that is relatively dust-proof and drip-proof but one that is not necessarily waterproof.

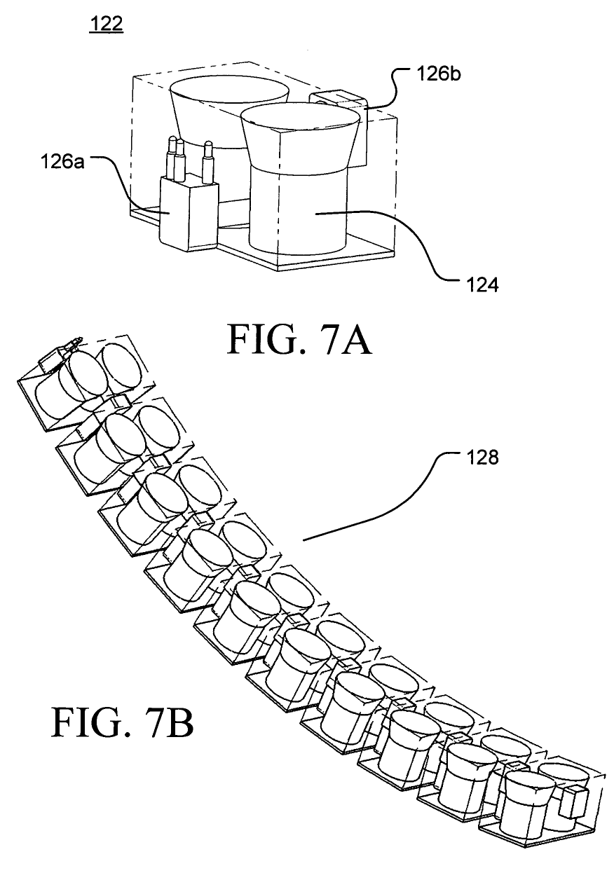

As indicated above, the present invention is not limited to a single transducer configuration and may incorporate, for example, both stacked, planar and configurable transducer arrays. One such configurable array is illustrated in FIG. 7B. As shown, the transducer array is constructed from a plurality of individual units 122 as illustrated in FIG. 7A, in this instance 2×1 transducer modules containing a pair of transducers 124, that are provided with submersible connections 126a, 126b generally corresponding to those above whereby a larger array may be assembled by sequentially inserting and connecting the individual units. This transducer configuration is especially useful in applications in which the access is very limited and/or in which it is desired to more closely conform the configuration of the transducer array to an interior surface of the vessel being cleaned. As will be appreciated by those skilled in the art, both the configuration of the modules 124, the placement of the connections 126a, 126b, and the number of modules utilized can be altered for fabricating a range of “planar” arrays 128 and increase the utility of the ultrasonic cleaning system 100.

As suggested in FIG. 7B, in order to install the planar transducer array in its intended location, each of the individual units 122 may be passed through even a relatively small hand hole, connected to the preceding unit 122, and then moved away from the opening and into the vessel. Thus, in applications unsuitable or generally inaccessible for traditionally-sized planar transducers, chains, for example a 1×10 chain as illustrated in FIG. 7B, or pads, for example a 4×4 array (not shown) of the smaller transducer 124 units may be assembled and utilized.

The connectors 126a, 126b are preferably configured to provide the transducer chains 128 with some amount of flexibility which allows them to conform to the curvature of the vessel wall with each chain of transducers being powered by a single generator, thereby reducing the required number of generators, cables, and electrical penetrations in the hand hole flange to achieve the desired power density.

We claim:

1. An ultrasonic cleaning system comprising:
a first plurality of N generators;
a second plurality of M·N transducers;
a switching unit for selectively connecting each of the N generators to a first group of N transducers or a second group of N transducers;
submersible connectors provided adjacent each transducer for establishing an electrical connection between the N generators and first and second groups of transducers.

2. The ultrasonic cleaning system according to claim 1, further comprising:
M/N switching units, each switching unit selectively connecting a dedicated group of N/(M/N) generators to corresponding groups of transducers.

3. The ultrasonic cleaning system according to claim 1, further comprising:
a switching control system incorporating at least one of local activation and remote activation for initiating transfer of power from a first group of transducers to a second group of transducers within the switching unit.
